(19) United States
(12) Patent Application Publication
(10) Pub. No.: US 2016/0132728 A1
(43) Pub. Date: May 12, 2016

(54) Near Online Multi-Target Tracking with Aggregated Local Flow Descriptor (ALFD)

(71) Applicant: NEC Laboratories America, Inc., Princeton, NJ (US)

(72) Inventor: Wongun Choi, Santa Clara, CA (US)

(21) Appl. No.: 14/872,551

(22) Filed: Oct. 1, 2015

Related U.S. Application Data
(60) Provisional application No. 62/078,765, filed on Nov. 12, 2014.
(60) Provisional application No. 62/151,094, filed on Apr. 22, 2015.

(51) Int. Cl. G06K 9/00; G06K 9/62; G06T 7/20; G06K 9/52

(52) U.S. Cl. CPC G06K 9/00711; G06K 9/52; G06K 9/6215; G06K 9/6256; G06T 7/20; G06K 2009/4666

(57) ABSTRACT

Systems and methods are disclosed to track targets in a video by capturing a video sequence, detecting data association between detections and targets, where detections are generated using one or more image based detectors (tracking-by-detections); identifying one or more target of interests and estimating a motion of each individual; and applying an Aggregated Local Flow Descriptor to accurately measure an affinity between a pair of detections and a Near Online Multi-target Tracking to perform multiple target tracking given a video sequence.

This application claims priority to Provision Applications 62/078,765 filed Nov. 12, 2014 and 62/151,094 filed Apr. 22, 2015, the contents of which are incorporated by reference.

### BACKGROUND

The present application relates to multi-target tracking of objects such as vehicles.

The goal of multiple target tracking is to automatically identify objects of interest and reliably estimate the motion of targets over the time. Thanks to the recent advancement in image-based object detection methods, tracking-by-detection has become a popular framework to tackle the multiple target tracking problem. The advantages of the framework are that it naturally identifies new objects of interest entering the scene, that it can handle video sequences recorded using mobile platforms, and that it is robust to a target drift. The challenge in this framework is to accurately group the detections into individual targets with high accuracy (data association), so one target could be fully represented by a single estimated trajectory. Mistakes made in the identity maintenance could result in a catastrophic failure in many high level reasoning tasks, such as future motion prediction, target behavior analysis, etc.

To implement a highly accurate multiple target tracking process, it is important to have a robust data association model and an accurate measure to compare two detections across time (pairwise affinity measure). Recently, much work is done in the design of the data association process using global (batch) tracking framework. Compared to the online counterparts, these methods have a benefit of considering all the detections over entire time frames. With a help of clever optimization processes, they achieve higher data association accuracy than traditional online tracking frameworks. However, the application of these methods is fundamentally limited to post-analysis of video sequences, since they need all the information at once. How to extend such framework toward time-sensitive applications, such as real-time surveillance, robotics, and autonomous vehicles, remains unclear. Although traditional online tracking processes are naturally applicable to these applications, the data association accuracy tends to be compromised when the scene is complex or there are erroneous detections (e.g. localization error, false positives, and missing detections). On the other hand, the pairwise affinity measure is relatively less investigated in the recent literature despite its importance. Most methods adopt weak affinity measures to compare two detections across time, such as spatial affinity (e.g. bounding box overlap or euclidean distance) or simple appearance similarity (e.g. intersection kernel with color histogram).

### SUMMARY

In one aspect, systems and methods are disclosed to track targets in a video by capturing a video sequence, estimating data association between detections and targets, where detections are generated using one or more image based detectors (tracking-by-detections); identifying one or more target of interests and estimating a motion of each individual; and applying an Aggregated Local Flow Descriptor to accurately measure an affinity between a pair of detections and a Near Online Multi-target Tracking to perform multiple target tracking given a video sequence.

In another aspect, an Aggregated Local Flow Descriptor (ALFD) encodes the relative motion pattern between a pair of temporally distant detections using long-term interest point trajectories (IPTs). Leveraging on the IPTs, the ALFD provides a robust affinity measure for estimating the likelihood of matching detections regardless of the application scenarios. A Near-Online Multi-target Tracking (NOMT) process. The tracking process becomes a data association between targets and detections in a temporal window that is repeatedly performed at every frame.

Advantages of the preferred embodiment may include one or more of the following. The system handles key aspects of multiple target tracking with an accurate affinity measure to associate detections and an efficient and accurate (near) online multiple target tracking process. The process can deliver much more accurate tracking results in unconstrained and complex scenario. The process is naturally applicable to real-time system, such as autonomous driving, robotics, and surveillance, where the timeliness is a critical requirement. As to latency in identifying targets and estimating the motion, the average latency is very low (about 3 frames/0.3 seconds) in practice. Moreover, the process can run almost in real-time. While being efficient, NOMT achieves robustness via integrating multiple cues including ALFD metric, target dynamics, appearance similarity, and long term trajectory regularization into the model. The ablative analysis verifies the superiority of the ALFD metric over the other conventional affinity metrics. In experiments with intensive tracking datasets, KITTI and MOT datasets. The NOMT method combined with ALFD metric achieves the best accuracy in both datasets with significant margins (about 10% higher MOTA) over the state-of-the-art systems.

### BRIEF DESCRIPTION OF THE DRAWINGS

FIG. 1 shows an exemplary multiple target tracking system.

FIG. 2 shows an example operation to obtain Aggregated Local Flow Descriptor for estimating the pairwise affinity between two detections.

FIG. 3 shows an exemplary smart car system that uses the tracking system of FIG. 1.

### DESCRIPTION

Given a video sequence, the method runs a detection process to obtain object hypotheses that may contain false-positives and miss some target objects. In parallel, the method compute optical flows using the Lucas-Kanade optical flow method to estimate local (pixel level) motion field in the images. Using the two inputs as well as images, the method generate a number of hypothetical trajectories for existing targets, and find the most consistent set of target trajectories using inference process that is based on the Conditional Random Field model. We compute the likelihood of each target hypothesis using a new motion based descriptor, which we call Aggregated Local Flow Descriptor (ALFD). The descriptor encodes the image-based spatial relationship between two detections in different time frames using the optical flow trajectories (shown as different colored shapes in the figure below). In this process, if the method identifies ambiguous target hypothesis (e.g. not enough supporting information, competition between different targets, etc), the decision is deferred to later time to avoid making errors. The deferred decision could be resolved when the method gathers more reliable information in the future.

The process applies “Near Online Multi-target Tracking” (NOMT) that achieves both timeliness and robustness. The problem is formulated as a data-association between targets and detections in multiple time frames, that is performed repeatedly at every frame. In order to avoid association errors, the process defers to make an association when it is ambiguous or challenging due to noisy observation or clustered scene. The data-association process includes a hypothesis testing framework, equipped with matching potentials that can solve the problem accurately and efficiently. The method is evaluated on a challenging KITTI dataset and the results demonstrate significant improvement in tracking accuracy compared to the other state-of-the-arts.

Our system addresses two challenging questions of the multiple target tracking problem: 1) how to accurately measure the pairwise affinity between two detections (i.e. likelihood to link the two) and 2) how to efficiently apply the ideas in global tracking processes into an online application. As for the first contribution, we present an Aggregated Local Flow Descriptor (ALFD) that encodes the relative motion pattern between two detection boxes in different time frames. By aggregating multiple local interest point trajectories (IPTs), the descriptor encodes how the IPTs in a detection moves with respect to another detection box, and vice versa. The main intuition is that although each individual IPT may have an error, collectively they provide a strong cue for comparing two detections. With a learned model, we observe that ALFD provides a strong affinity measure. As for the second contribution, we use an efficient Near-Online Multi-target Tracking (NOMT) process. Incorporating the robust ALFD descriptor as well as long-term motion/appearance models, the process produces highly accurate trajectories, while preserving the causality and real-time (:10 FPS) property. In every frame t, the process solves the global data association problem between targets and all the detections in a temporal window [t−τ, t] of size r. The key property is that the process has the potential to fix any past association error within the temporal window when more detections are provided. In order to achieve both accuracy and efficiency, the process generates candidate hypothetical trajectories using ALFD driven tracklets and solve the association problem with a parallelized junction tree process.

Given a video sequence V₁^{T}={I₁, I₂, . . . , I_{T}} of length T and a set of detection hypotheses D₁^{T}={d₁, d₂, . . . , d_{N}}, where dᵢ is parameterized by the frame number tᵢ, a bounding box (dᵢ[x], dᵢ[y], dᵢ[w], dᵢ[h])¹, and the score sᵢ, the goal of multiple target tracking is to find a coherent set of targets (associations) A={A₁, A₂, . . . , A_{M}}, where each target Aₘ are parameterized by a set of detection indices (e.g. A₁={d₁, d₁₀, d₂₃}) during the time of presence. ¹[x], [y], [w], [h] operators represent the x, y, width and height value, respectively.

Data Association Models: Most of multiple target tracking processes/systems can be classified into two categories: online method and global (batch) method. Online processes are formulated to find the association between existing targets and detections in the current time frame: (Vₜ^{t}, Dₜ^{t}, A^{t-1})→A^{t}. The advantages of online formulation are: 1) it is applicable to online/real-time scenario and 2) it is possible to take advantage of targets' dynamics information available in A^{t-1}. Such methods, however, are often prone to association errors since they consider only one frame when making the association. Recently, global techniques became much popular in the community, as more robust association is achieved when considering long-term information in the association process. One common approach is to formulate the tracking as the network flow problem to directly obtain the targets from detection hypothesis; i.e. (V₁^{T}, D₁^{T})→A^{T}. Although they have shown promising accuracy in multiple target tracking, the methods are often over-simplified for the tractability concern. They ignore useful target level information, such as target dynamics and interaction between targets (occlusion, social interaction, etc). Instead of directly solving the problem at one step, other employ an iterative process that progressively refines the target association; i.e. (V₁^{T}, D₁^{T}, Dᵢ^{T})→Aᵢ₊₁^{T}, where i represent an iteration.

We use a framework that can fill in the gap between the online and global processes. The task is defined as to solve the following problem: (V₁^{t}, D_{t-τ}^{t}, A^{t-1})→A^{t} in each time frame t, where τ is pre-defined temporal window size. Our process behaves similar to the online process in that it outputs the association in every time frame. The critical difference is that any decision made in the past is subject to change once more observations are available. The association problems in each temporal window are solved using a newly used global association process. Our method is also reminiscent of iterative global process, since we augment all the track iteratively (one iteration per frame) considering multiple frames, that leads to a better association accuracy.

Affinity Measures in Visual Tracking: The importance of a robust pairwise affinity measure (i.e. likelihood of dᵢ and dⱼ being the same target) is relatively less investigated in the multi-target tracking literature. The Aggregated Local Flow Descriptor (ALFD) encodes the relative motion pattern between two bounding boxes in a temporal distance (Δt=|tᵢ−tⱼ|) given interest point trajectories. The main intuition in ALFD is that if the two boxes belong to the same target, we shall observe many supporting IPTs in the same relative location with respect to the boxes. In order to make it robust against small localization errors in detections, targets' orientation change, and outliers/errors in the IPTs, we build the ALFD using spatial histograms. Once the ALFD is obtained, we measure the affinity between two detections (a_{A}(dᵢ, dⱼ)) using the linear product of a learned model parameter (w_{Δt}) and ALFD (ρ(dᵢ, dⱼ)), i.e. a_{A}(dᵢ, dⱼ)=w_{Δt}·ρ(dᵢ, dⱼ). In the following subsections, we discuss the details of the design.

We obtain Interest Point Trajectories using a local interest point detector and optical flow process. The process is designed to produce a set of long and accurate point trajectories, combining various well-known computer vision techniques. Given an image Iₜ, we run the FAST interest point detector to identify “good points” to track. In order to avoid having redundant points, we compute the distance between the newly detected interest points and the existing IPTs and keep the new points sufficiently far from the existing IPTs (>4 px). The new points are assigned unique IDs. For all the IPTs in t, we compute the forward (t→t+1) and backward (t+1→t) optical flow. The starting points of backward flows are given by the forward flows' end point. Any IPT having a large disagreement between the two (>10 px) is terminated.

For the ALFD Design, we define the necessary notations to discuss ALFD. κ_{id}εK represents one IPT with a unique id. κ_{id} is parameterized by pixel locations (κ_{id}(t)[x], κ_{id}(t)[y]) during the time of presence. We define κ_{id}(t) to denote the pixel location at the frame t. If κ_{id} does not exist at t (terminated or not initiated), ø is returned.

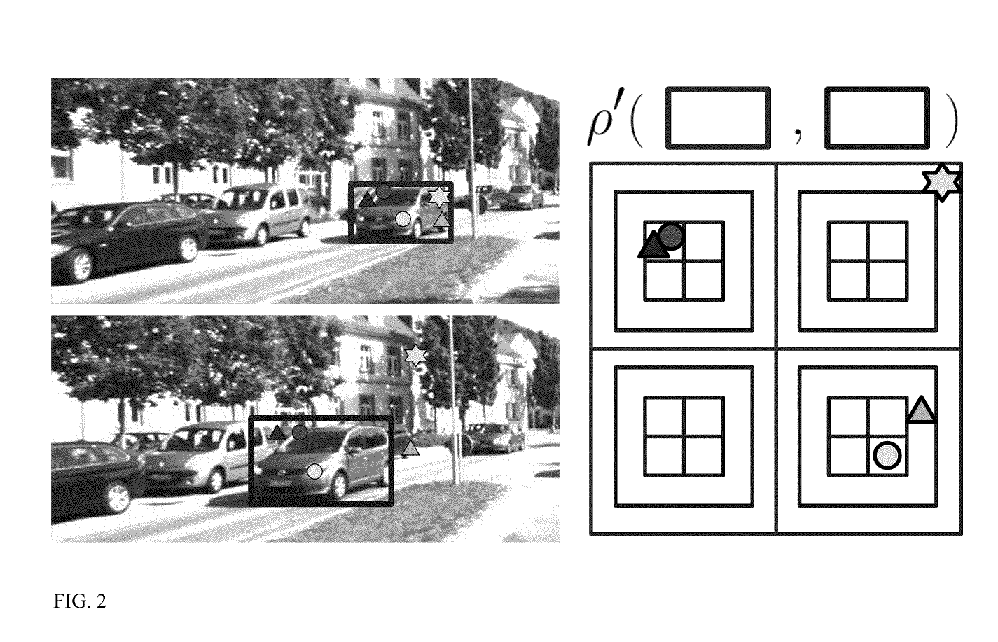

We first define a unidirectional ALFD ρ′(dᵢ, dⱼ), i.e. motion pattern from dᵢ to dⱼ, by aggregating the information from all the IPTs that are located inside of dᵢ box and existing at tⱼ. Formally, we define the IPT set as K(dᵢ, dⱼ) {κ_{id}|κ_{id}(tᵢ)εdᵢ&κ(tⱼ)≠ø}. For each κ_{id}εK(dᵢ, dⱼ), we compute the relative location rᵢ(κ_{id}))=(x, y) of each κ_{id} at tᵢ by rᵢ(κ_{id})[x]=(κ_{id}(tᵢ)[x]−dᵢ[x])/dᵢ[w] and rᵢ(κ_{id})[y]=(κ_{id}(tᵢ)[y]−dᵢ[y])/dᵢ[h]. We compute rⱼ(κ_{id}) similarly. Notice that rᵢ(κ_{id}) are bounded between [0,1], but rⱼ(κ_{id}) are not bounded since κ_{id} can be outside of dⱼ. Given the rᵢ(κ_{id}) and rⱼ(κ_{id}), we compute the corresponding spatial grid bin indices as shown in the FIG. 2 and accumulate the count to build the descriptor. We define 4×4 grids for rᵢ(κ_{id}) and 4×4+2 grids for rⱼ(κ_{id})) where the last 2 bins are accounting for the outside region of the detection. The first outside bin defines the neighborhood of the detection (<width/4&<height/4), and the second outside bin represents any farther region.

Using a pair of unidirectional ALFDs, we define the (undirected) ALFD as ρ(dᵢ, dⱼ)=(ρ′(dᵢ, dⱼ)+ρ′(dⱼ, dᵢ))/n(dᵢ, dⱼ), where n(dᵢ, dⱼ) is a normalizer. The normalizer n is defined as n(dᵢ, dⱼ)=|K(dᵢ, dⱼ)|+|K(dⱼ, dᵢ)|+λ, where |K(•)| is the count of IPTs and λ is a constant. λ ensures that the L1 norm of the ALFD increases as we have more supporting K(dᵢ, dⱼ) and converges to 1. We use λ=20 in practice.

In Learning the Model Weights, we learn the model parameters w_{Δt} from a training dataset with a weighted voting. Given a set of detections Dᵢ^{T} and corresponding ground truth (GT) target annotations, we first assign the GT target id to each detections. For each detection dᵢ, we measure the overlap with all the GT boxes in tᵢ. If the best overlap oᵢ is larger than 0.5, the corresponding target id (idᵢ) is assigned. Otherwise, −1 is assigned. For all detections that has idᵢ≧0 (positive detections), we collect a set of detections Pᵢ^{Δt}={dⱼεD₁^{T}|tⱼ−tᵢ=Δt}. For each pair, we compute the margin mᵢⱼ as follows: if idᵢ and idⱼ are identical, mᵢⱼ=(oᵢ−0.5)·(oⱼ−0.5). Otherwise, mᵢⱼ=−(oᵢ−0.5)·(oⱼ−0.5). Intuitively, mᵢⱼ shall have a positive value if the two detections are from the same target, while mᵢⱼ have a negative value, if the dᵢ and dⱼ are from different targets. The magnitude is weighted by the localization accuracy. Given all the pairs and margins, we learn the model w_{Δt} as follows:

$${w}_{Δ t} = \frac{{\sum }_{\{ i ∈ {D}_{1}^{T} \vert {id}_{i} \geq 0 \}} {\sum }_{j ∈ {P}_{i}^{Δ t}} {m}_{ij} ( {ρ}^{′} ( {d}_{i} , {d}_{j} ) + {ρ}^{′} ( {d}_{j} , {d}_{i} ) )}{{\sum }_{\{ i ∈ {D}_{1}^{T} \vert {id}_{i} \geq 0 \}} {\sum }_{j ∈ {P}_{i}^{Δ t}} \vert {m}_{ij} \vert ( {ρ}^{′} ( {d}_{i} , {d}_{j} ) + {ρ}^{′} ( {d}_{j} , {d}_{i} ) )} \qquad ( 1 )$$

where the division is performed element-wise. The process computes a weighted average with a sign over all the ALFD patterns, where the weights are determined by the overlap between targets and detections. Intuitively, the ALFD pattern between detections that matches well with GT contributes more on the model parameters. The advantage of the weighted voting method is that each element in w_{Δt} are bounded in [−1,1], thus the ALFD metric, a_{A}(dᵢ, dⱼ), is also bounded by [−1,1] since ∥ρ(dᵢ, dⱼ)∥₁≦1. We learn w_{Δt} using the KITTI 0000 sequence and kept the same parameter throughout all the experiments.

Next we discuss the properties of ALFD affinity metric a_{A}(dᵢ, dⱼ). Firstly, unlike appearance or spatial metrics, ALFD implicitly exploit the information in all the images between tᵢ and tⱼ through IPTs. Secondly, thanks to the collective nature of ALFD design, it provides strong affinity metric over arbitrary length of time. We observe a significant benefit over the appearance or spatial metric especially over a long temporal distance (see Sec. 5.1 for the analysis). Thirdly, it is generally applicable to any scenarios (either static or moving camera) and for any object types (person or car). One disadvantage of the ALFD is that it may become unreliable when there is an occlusion. When an occlusion happens to a target, the IPTs initiated from the target tend to adhere to the occluder.

Near Online Multi-target Tracking (NOMT) is discussed next. We employ a near-online multi-target tracking framework that updates and outputs targets A^{t} in each time frame considering inputs in a temporal window [t−τ, t]. We implement the NOMT process with a hypothesis generation and selection scheme. For the convenience of discussion, we define clean targets A^{*t-1}={A₁^{*t-1}−1, A₂^{*t-1}−1, . . . } that exclude all the associated detections in [t−1]−τ, t−1]. Given a set of detections in [t−1−τ, t] and clean targets A^{*t-1}, we generate multiple target hypotheses Hₘ^{t}={ø, H_{m,2}^{t}, H_{m,3}^{t} . . . } for each target Aₘ^{*t-1} as well as newly entering targets, where ø (empty hypothesis) represents the termination of the target and each H_{m,k}^{t} indicates a set of candidate detections in [t−τ, t] that can be associated to a target. Each H_{m,k}^{t} may contain 0 to τ detections (at one time frame, there can be 0 or 1 detection). Given the set of hypotheses for all the existing and new targets, the process finds the most consistent set of hypotheses (MAP) for all the targets (one for each) using a graphical model. As the key characteristic, our process can fix any association error (for the detections within the temporal window [t−τ, t]) made in the previous time frames.

Before going into the details of each step, we discuss our underlying model representation. The model is formulated as an energy minimization framework; \hat{x}=argminₓE(A^{*t-1}−1, H^{t}(x), Dₜ₋₁−τ^{t}, V₁^{t}), where x is an integer state vector indicating which hypothesis is chosen for a corresponding target, H^{t} is the set of all the hypotheses {Hᵢ^{t}, H₂^{t}, . . . }, and H^{t}(x) is a set of selected hypothesis {H_{1,x}_{₁}^{t}, H_{2,x}_{₂}^{t}, . . . }. Solving the optimization, the updated targets A^{t} can be uniquely identified by augmenting A^{*t-1}−1 with the selected hypothesis H^{t}(\hat{x}). Hereafter, we drop V₁^{t} and Dₜ₋₁−τ^{t} to avoid clutters in the equations. The energy is defined as follows:

$$E ( {A}^{* t - 1} , {H}^{t} ( x ) ) = {\sum }_{m} Ψ ( {A}_{m}^{* t - 1} , {H}_{m , {x}_{m}}^{t} ) + {\sum }_{m , l} Φ ( {H}_{m , {x}_{m}}^{t} , {H}_{l , {x}_{l}}^{t} ) \qquad ( 2 )$$

where Ψ(•) encodes individual target's motion, appearance, and ALFD metric consistency, and Φ(•) represent an exclusive relationship between different targets (e.g. no two targets share the same detection). If there are hypotheses for newly entering targets, we define the corresponding target as an empty set, Aₘ^{*t-1}=ø.

The potential measures the compatibility of a hypothesis H_{m,x}_{ₘ}^{t} to a target Aₘ^{*t-1}−1. Mathematically, this can be decomposed into unary, pairwise and high order terms as follows:

$$Ψ ( {A}_{m}^{* t - 1} , {H}_{m , {x}_{m}}^{t} ) = {\sum }_{i ∈ {H}_{m , {x}_{m}}^{t}} {ψ}_{u} ( {A}_{m}^{* t - 1} , {d}_{i} ) + {\sum }_{( i , j ) ∈ {H}_{m , {x}_{m}}^{t}} {ψ}_{p} ( {d}_{i} , {d}_{j} ) + {ψ}_{h} ( {A}_{m}^{* t - 1} , {H}_{m , {x}_{m}}^{t} ) \qquad ( 3 )$$

ψᵤ encodes the compatibility of each detection dᵢ in the target hypothesis H_{m,x}_{ₘ}^{t} using the ALFD affinity metric and Target Dynamics feature. ψₚ measures the pairwise compatibility (self-consistency of the hypothesis) between detections within H_{m,x}_{ₘ}^{t} using the ALFD metric. Finally, ψₕ implements a long-term smoothness constraint and appearance consistency.

This potential penalizes choosing two targets with large overlap in the image plane (repulsive force) as well as duplicate assignments of a detection. The potential can be written as follows:

$$Φ ( {H}_{m , {x}_{m}}^{t} , {H}_{l , {x}_{l}}^{t} ) = {\sum }_{f = t - τ}^{t} α \cdot {o}^{2} ( d ( {H}_{m , {x}_{m}}^{t} , f ) , d ( {H}_{l , {x}_{l}}^{t} , f ) ) + β \cdot \vert ( d ( {H}_{m , {x}_{m}}^{t} , f ) , d ( {H}_{l , {x}_{l}}^{t} , f ) ) \qquad ( 4 )$$

where d(H_{m,x}_{ₘ}^{t}, f) gives the associated detection of H_{m,x}_{ₘ}^{t} at time f (if none, ø is returned), o²(dᵢ, dⱼ)=2*IoU(dᵢ, dⱼ)², and I(dᵢ, dⱼ) is an indicator function. The former penalizes having too much overlap between hypotheses and the later penalizes duplicate assignments of detections. We use α=0.5 and β=100 (large enough to avoid duplicate assignments).

Hypothesis generation is discussed next. Direct optimization over the aforementioned objective function (eq. 2) is infeasible since the space of H^{t} is huge in practice. To cope with the challenge, we first use a set of candidate hypotheses Hₘ for each target independently and find a coherent solution (MAP) using a CRF inference process. As all the subsequent steps depend on the generated hypotheses, it is critical to have a comprehensive set of target hypotheses. We generates the hypotheses of existing and new targets using tracklets. Notice that following steps could be done in parallel since we generate the hypotheses set per target independently.

For all the confident detections, we build a tracklet using the ALFD metric a_{A}. Starting from one detection tracklet Tᵢ={dᵢ}, we grow the tracklet by greedily adding the best matching detection dₖ such that k=argmax_{kεD}_{ₜ₋₁}−τ^{t}\Tᵢmax_{jεT}_{ᵢ}a_{A}(dⱼ, dₖ), where D t−τ^{t}\Tᵢ is the set of detections in [t−τ, t] excluding the frames already included in Tᵢ. If the best ALFD metric is lower than 0.4 or Tᵢ is full (has τ number of detections), the iteration is terminated. In addition, we also extracts the residual detections from each Aₘ^{t-1} in [t−τ, t] to obtain additional tracklets. Since there can be identical tracklets, we keep only unique tracklets in the output set T.

Next we discuss hypotheses for existing targets. We generate a set of target hypotheses Hₘ^{t} for each existing target A^{*t-1} using the tracklets T. In order to avoid having unnecessarily large number of hypotheses, we employ a gating strategy. For each target Aₘ^{*t-1}, we obtain a target predictor using the least square process with polynomial function. We vary the order of the polynomial depending on the dataset (1 for MOT and 2 for KITTI). If there is an overlap (IoU) larger than a certain threshold between the prediction and the detections in the tracklet Tᵢ at any frame in t−τ, t], we add Tᵢ to the hypotheses set Hₘ^{t}. In practice, we use a conservative threshold 0.1 to have a rich set of hypotheses. Too old targets (having no associated detection in t−τ−T_{active}, t]) are ignored to avoid unnecessary computational burden. We use T_{active}=1 sec.

Since new targets can enter the scene at any time and at any location, it is desirable to automatically identify new targets. Our process can naturally identify the new targets by treating any tracklet in the set T as a potential new target. We use a non-maximum suppression on tracklets to avoid having duplicate new targets. For each tracklet Tᵢ, we simply add an empty target Aₘ^{*t-1}=0 to A^{*t-1} with an associated hypotheses set Hₘ^{t}={ø, Tᵢ}.

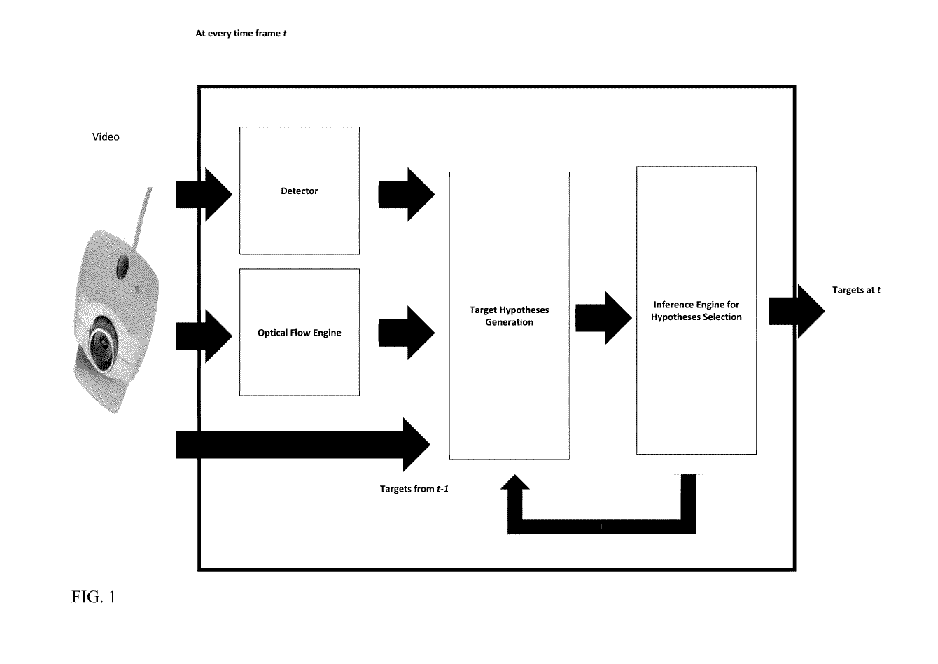

Inference with Dynamic Graphical Model is detailed next. Once we have all the hypotheses for all the new and existing targets, the problem (eq. 2) can be formulated as an inference problem with an undirected graphical model, where one node represents a target and the states are hypothesis indices as shown in FIG. 1 (c). The main challenges in this problem are: 1) there may exist loops in the graphical model representation and 2) the structure of graph is different depending on the hypotheses at each circumstance. In order to obtain the exact solution efficiently, we first analyze the structure of the graph on the fly and apply appropriate inference processes based on the structure analysis.

Given the graphical model, we find independent subgraphs using connected component analysis and perform individual inference process per each subgraph in parallel. If a subgraph is composed of more than one node, we use junction-tree process to obtain the solution for corresponding subgraph. Otherwise, we choose the best hypothesis for the target. Once the states x are found, we can uniquely identify the new set of targets by augmenting A^{*t-1} with H^{t}(x): A^{*t-1}−1+H^{t}(x)→A^{t}. This process allows us to adjust any associations of A^{t-1} in t−τ, t] (i.e. addition, deletion, replacement, or no modification).

As discussed in the previous sections, we utilize the ALFD metric as the main affinity metric to compare detections. The unary potential for each detection in the hypothesis is measured by:

$${μ}_{A} ( {A}_{m}^{* t - 1} , {d}_{i} ) = - {\sum }_{Δ t ∈ N} {a}_{A} ( d ( {A}_{m}^{* t - 1} , {t}_{i} - Δ t ) , {d}_{i} ) \qquad ( 5 )$$

where N is a predefined set of neighbor frame distances and d(ₘ^{*t-1}−1, tᵢ) gives the associated detection of Aₘ^{*t-1}−1 at tᵢ. Although we can define an arbitrarily large set of N, we choose N={1, 2, 5, 10, 20} for computational efficiency while modeling long term affinity measures.

Although ALFD metric provides very strong information in most of the cases, there are few failure cases including occlusions, erroneous IPTs, etc. To complement such cases, we design an additional Target Dynamics (TD) feature μ_{T}(Aₘ^{*t-1]}−1, dᵢ). Using the same polynomial least square predictor discussed in Sec. 4.2, we define the feature as follows:

$${μ}_{T} ( {A}_{m}^{* t - 1} , {d}_{i} ) = \{ \begin{matrix}∞ , & if {o}^{2} ( p ( {A}_{m}^{* t - 1} , {t}_{i} ) , {d}_{i} ) < 0.5 \\ - {η}^{{t}_{i} - f ( {A}_{m}^{* t - 1} )} {o}^{2} ( p ( {A}_{m}^{* t - 1} , {t}_{i} ) , {d}_{i} ) , & otherwise\end{matrix} \qquad ( 6 )$$

where η is a decay factor (0.98) that discounts long term prediction, f(Aₘ^{*t-1]}) denotes the last associated frame of Aₘ^{*t-1}, o² represents IoU², and p is the polynomial least square predictor.

Using the two measures, we define the unary potential ψᵤ(Aₘ^{*t-1}, dᵢ) as:

ψᵤ(Aₘ^{*t-1},dᵢ)=min(μ_{A}(Aₘ^{*t-1},dᵢ),μ_{T}(Aₘ^{*t-1},dᵢ))−sᵢ (7)

where sᵢ represents the detection score of dᵢ. The min operator enables us to utilize the ALFD metric in most cases, but activate the TD metric only when it is very confident (more than 0.5 overlap between the prediction and the detection). If Aₘ^{*t-1} is empty, the potential becomes −sᵢ.

The pairwise potential ψₚ(•) is solely defined by the ALFD metric. Similarly to the unary potential, we define the pairwise relationship between detections in H_{m,x}_{ₘ}^{t},

$${ψ}_{p} ( {d}_{i} , {d}_{j} ) = \{ \begin{matrix}- {a}_{A} ( {d}_{i} , {d}_{j} ) , & if \vert {d}_{i} - {d}_{j} \vert ∈ N \\ 0 , & otherwise\end{matrix} \qquad ( 8 )$$

It measures the self-consistency of a hypothesis H_{m,x}_{ₘ}^{t}.

We incorporate a high-order potential to regularize the target association process with a physical feasibility and appearance similarity. Firstly, we implement the physical feasibility by penalizing the hypotheses that present an abrupt motion. Secondly, we encodes long term appearance similarity between all the detections in Aₘ^{*t-1} and H_{m,x}_{ₘ}^{t}. The intuition is encoded by the following potential:

$${ψ}_{h} ( {A}_{m}^{* t - 1} , {H}_{m , {x}_{m}}^{t} ) = γ \cdot {\sum }_{i ∈ {H}_{m , {x}_{m}}^{t}} ξ ( p ( {A}_{m}^{* t - 1} ⋃ {H}_{m , {x}_{m}}^{t} , {t}_{i} ) , {d}_{i} ) + ɛ \cdot {\sum }_{( i , j ) ∈ {A}_{m}^{* t - 1} ⋃ {H}_{m , {x}_{m}}^{t}} θ - K ( {d}_{i} , {d}_{j} ) \qquad ( 9 )$$

where γ, ε, θ are scalar parameters, ξ(a, b) measures the sum of squared distances in (x, y, height) of the two boxes, that is normalized by the mean height of p in [t−τ, t], and K(dᵢ, dⱼ) represents the intersection kernel for color histograms associated with the detections.

We use a pyramid of LAB color histogram where the first layer is the full box and the second layer is 3×3 grids. Only the A and B channels are used for the histogram with 4 bins per each channel (resulting in 4×4×(1+9) bins). We use (γ, ε, θ)=(20, 0.4, 0.8) in practice.

Our controlled experiment demonstrates that ALFD based affinity metric is significantly better than other conventional affinity metrics. Equipped with ALFD, our NOMT process generates significantly better tracking results on two challenging large-scale datasets. In addition, our method runs in real-time that enables us to apply it to various applications including autonomous driving, real-time surveillance, etc.

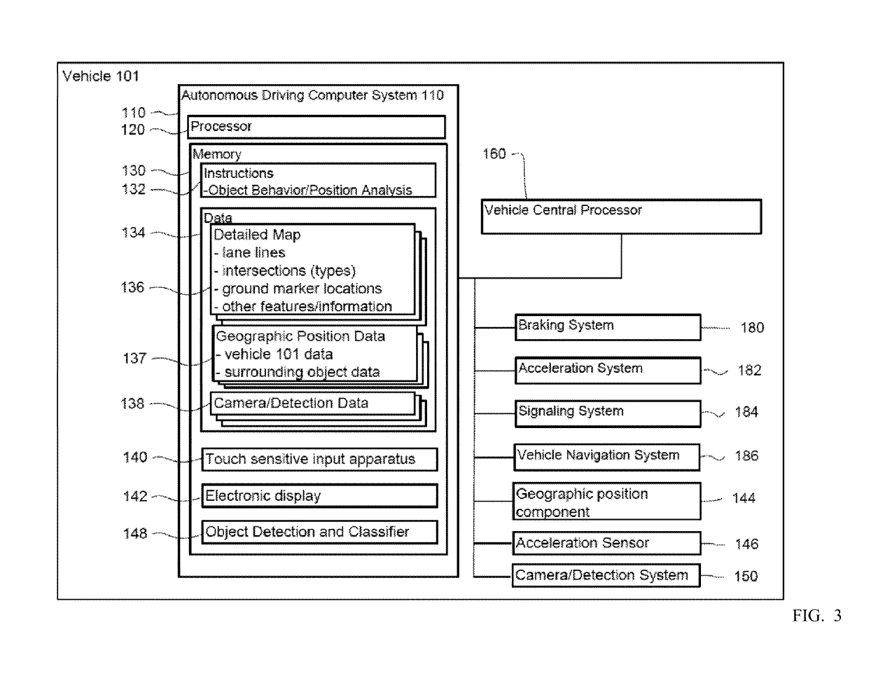

As shown in FIG. 3, an autonomous driving system 100 in accordance with one aspect includes a vehicle 101 with various components. While certain aspects are particularly useful in connection with specific types of vehicles, the vehicle may be any type of vehicle including, but not limited to, cars, trucks, motorcycles, busses, boats, airplanes, helicopters, lawnmowers, recreational vehicles, amusement park vehicles, construction vehicles, farm equipment, trams, golf carts, trains, and trolleys. The vehicle may have one or more computers, such as computer 110 containing a processor 120, memory 130 and other components typically present in general purpose computers.

The memory 130 stores information accessible by processor 120, including instructions 132 and data 134 that may be executed or otherwise used by the processor 120. The memory 130 may be of any type capable of storing information accessible by the processor, including a computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the system and method is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

The processor 120 may be any conventional processor, such as commercial CPUs. Alternatively, the processor may be a dedicated device such as an ASIC. Although FIG. 1 functionally illustrates the processor, memory, and other elements of computer 110 as being within the same block, it will be understood by those of ordinary skill in the art that the processor and memory may actually comprise multiple processors and memories that may or may not be stored within the same physical housing. For example, memory may be a hard drive or other storage media located in a housing different from that of computer 110. Accordingly, references to a processor or computer will be understood to include references to a collection of processors, computers or memories that may or may not operate in parallel. Rather than using a single processor to perform the steps described herein some of the components such as steering components and deceleration components may each have their own processor that only performs calculations related to the component's specific function.

In various aspects described herein, the processor may be located remotely from the vehicle and communicate with the vehicle wirelessly. In other aspects, some of the processes described herein are executed on a processor disposed within the vehicle and others by a remote processor, including taking the steps necessary to execute a single maneuver.

Computer 110 may include all of the components normally used in connection with a computer such as a central processing unit (CPU), memory (e.g., RAM and internal hard drives) storing data 134 and instructions such as a web browser, an electronic display 142 (e.g., a monitor having a screen, a small LCD touch-screen or any other electrical device that is operable to display information), user input (e.g., a mouse, keyboard, touch screen and/or microphone), as well as various sensors (e.g. a video camera) for gathering the explicit (e.g., a gesture) or implicit (e.g., “the person is asleep”) information about the states and desires of a person.

The vehicle may also include a geographic position component 144 in communication with computer 110 for determining the geographic location of the device. For example, the position component may include a GPS receiver to determine the device's latitude, longitude and/or altitude position. Other location systems such as laser-based localization systems, inertia-aided GPS, or camera-based localization may also be used to identify the location of the vehicle. The vehicle may also receive location information from various sources and combine this information using various filters to identify a “best” estimate of the vehicle's location. For example, the vehicle may identify a number of location estimates including a map location, a GPS location, and an estimation of the vehicle's current location based on its change over time from a previous location. This information may be combined together to identify a highly accurate estimate of the vehicle's location. The “location” of the vehicle as discussed herein may include an absolute geographical location, such as latitude, longitude, and altitude as well as relative location information, such as location relative to other cars in the vicinity which can often be determined with less noise than absolute geographical location.

The device may also include other features in communication with computer 110, such as an accelerometer, gyroscope or another direction/speed detection device 146 to determine the direction and speed of the vehicle or changes thereto. By way of example only, device 146 may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the user, computer 110, other computers and combinations of the foregoing.

The computer may control the direction and speed of the vehicle by controlling various components. By way of example, if the vehicle is operating in a completely autonomous mode, computer 110 may cause the vehicle to accelerate (e.g., by increasing fuel or other energy provided to the engine), decelerate (e.g., by decreasing the fuel supplied to the engine or by applying brakes) and change direction (e.g., by turning the front wheels).

The vehicle may include components 148 for detecting objects external to the vehicle such as other vehicles, obstacles in the roadway, traffic signals, signs, trees, etc. The detection system may include lasers, sonar, radar, cameras or any other detection devices. For example, if the vehicle is a small passenger car, the car may include a laser mounted on the roof or other convenient location. In one aspect, the laser may measure the distance between the vehicle and the object surfaces facing the vehicle by spinning on its axis and changing its pitch. The laser may also be used to identify lane lines, for example, by distinguishing between the amount of light reflected or absorbed by the dark roadway and light lane lines. The vehicle may also include various radar detection units, such as those used for adaptive cruise control systems. The radar detection units may be located on the front and back of the car as well as on either side of the front bumper. In another example, a variety of cameras may be mounted on the car at distances from one another which are known so that the parallax from the different images may be used to compute the distance to various objects which are captured by one or more cameras, as exemplified by the camera of FIG. 1. These sensors allow the vehicle to understand and potentially respond to its environment in order to maximize safety for passengers as well as objects or people in the environment.

In addition to the sensors described above, the computer may also use input from sensors typical of non-autonomous vehicles. For example, these sensors may include tire pressure sensors, engine temperature sensors, brake heat sensors, brake pad status sensors, tire tread sensors, fuel sensors, oil level and quality sensors, air quality sensors (for detecting temperature, humidity, or particulates in the air), etc.

Many of these sensors provide data that is processed by the computer in real-time; that is, the sensors may continuously update their output to reflect the environment being sensed at or over a range of time, and continuously or as-demanded provide that updated output to the computer so that the computer can determine whether the vehicle's then-current direction or speed should be modified in response to the sensed environment.

These sensors may be used to identify, track and predict the movements of pedestrians, bicycles, other vehicles, or objects in the roadway. For example, the sensors may provide the location and shape information of objects surrounding the vehicle to computer 110, which in turn may identify the object as another vehicle. The object's current movement may be also be determined by the sensor (e.g., the component is a self-contained speed radar detector), or by the computer 110, based on information provided by the sensors (e.g., by comparing changes in the object's position data over time).

The computer may change the vehicle's current path and speed based on the presence of detected objects. For example, the vehicle may automatically slow down if its current speed is 50 mph and it detects, by using its cameras and using optical-character recognition, that it will shortly pass a sign indicating that the speed limit is 35 mph. Similarly, if the computer determines that an object is obstructing the intended path of the vehicle, it may maneuver the vehicle around the obstruction.

The vehicle's computer system may predict a detected object's expected movement. The computer system 110 may simply predict the object's future movement based solely on the object's instant direction, acceleration/deceleration and velocity, e.g., that the object's current direction and movement will continue.

Once an object is detected, the system may determine the type of the object, for example, a traffic cone, person, car, truck or bicycle, and use this information to predict the object's future behavior. For example, the vehicle may determine an object's type based on one or more of the shape of the object as determined by a laser, the size and speed of the object based on radar, or by pattern matching based on camera images. Objects may also be identified by using an object classifier which may consider one or more of the size of an object (bicycles are larger than a breadbox and smaller than a car), the speed of the object (bicycles do not tend to go faster than 40 miles per hour or slower than 0.1 miles per hour), the heat coming from the bicycle (bicycles tend to have a rider that emits body heat), etc.

In some examples, objects identified by the vehicle may not actually require the vehicle to alter its course. For example, during a sandstorm, the vehicle may detect the sand as one or more objects, but need not alter its trajectory, though it may slow or stop itself for safety reasons.

In another example, the scene external to the vehicle need not be segmented from input of the various sensors, nor do objects need to be classified for the vehicle to take a responsive action. Rather, the vehicle may take one or more actions based on the color and/or shape of an object.

The system may also rely on information that is independent of the detected object's movement to predict the object's next action. By way of example, if the vehicle determines that another object is a bicycle that is beginning to ascend a steep hill in front of the vehicle, the computer may predict that the bicycle will soon slow down—and will slow the vehicle down accordingly—regardless of whether the bicycle is currently traveling at a relatively high speed.

It will be understood that the foregoing methods of identifying, classifying, and reacting to objects external to the vehicle may be used alone or in any combination in order to increase the likelihood of avoiding a collision.

By way of further example, the system may determine that an object near the vehicle is another car in a turn-only lane (e.g., by analyzing image data that captures the other car, the lane the other car is in, and a painted left-turn arrow in the lane). In that regard, the system may predict that the other car may turn at the next intersection.

The computer may cause the vehicle to take particular actions in response to the predicted actions of the surrounding objects. For example, if the computer 110 determines that another car approaching the vehicle is turning, for example based on the car's turn signal or in which lane the car is, at the next intersection as noted above, the computer may slow the vehicle down as it approaches the intersection. In this regard, the predicted behavior of other objects is based not only on the type of object and its current trajectory, but also based on some likelihood that the object may or may not obey traffic rules or pre-determined behaviors. This may allow the vehicle not only to respond to legal and predictable behaviors, but also correct for unexpected behaviors by other drivers, such as illegal u-turns or lane changes, running red lights, etc.

In another example, the system may include a library of rules about object performance in various situations. For example, a car in a left-most lane that has a left-turn arrow mounted on the light will very likely turn left when the arrow turns green. The library may be built manually, or by the vehicle's observation of other vehicles (autonomous or not) on the roadway. The library may begin as a human-built set of rules which may be improved by vehicle observations. Similarly, the library may begin as rules learned from vehicle observation and have humans examine the rules and improve them manually. This observation and learning may be accomplished by, for example, tools and techniques of machine learning.

In addition to processing data provided by the various sensors, the computer may rely on environmental data that was obtained at a previous point in time and is expected to persist regardless of the vehicle's presence in the environment. For example, data 134 may include detailed map information 136, for example, highly detailed maps identifying the shape and elevation of roadways, lane lines, intersections, crosswalks, speed limits, traffic signals, buildings, signs, real time traffic information, or other such objects and information. Each of these objects such as lane lines or intersections may be associated with a geographic location which is highly accurate, for example, to 15 cm or even 1 cm. The map information may also include, for example, explicit speed limit information associated with various roadway segments. The speed limit data may be entered manually or scanned from previously taken images of a speed limit sign using, for example, optical-character recognition. The map information may include three-dimensional terrain maps incorporating one or more of objects listed above. For example, the vehicle may determine that another car is expected to turn based on real-time data (e.g., using its sensors to determine the current GPS position of another car) and other data (e.g., comparing the GPS position with previously-stored lane-specific map data to determine whether the other car is within a turn lane).

In another example, the vehicle may use the map information to supplement the sensor data in order to better identify the location, attributes, and state of the roadway. For example, if the lane lines of the roadway have disappeared through wear, the vehicle may anticipate the location of the lane lines based on the map information rather than relying only on the sensor data.

The vehicle sensors may also be used to collect and supplement map information. For example, the driver may drive the vehicle in a non-autonomous mode in order to detect and store various types of map information, such as the location of roadways, lane lines, intersections, traffic signals, etc. Later, the vehicle may use the stored information to maneuver the vehicle. In another example, if the vehicle detects or observes environmental changes, such as a bridge moving a few centimeters over time, a new traffic pattern at an intersection, or if the roadway has been paved and the lane lines have moved, this information may not only be detected by the vehicle and used to make various determination about how to maneuver the vehicle to avoid a collision, but may also be incorporated into the vehicle's map information. In some examples, the driver may optionally select to report the changed information to a central map database to be used by other autonomous vehicles by transmitting wirelessly to a remote server. In response, the server may update the database and make any changes available to other autonomous vehicles, for example, by transmitting the information automatically or by making available downloadable updates. Thus, environmental changes may be updated to a large number of vehicles from the remote server.

In another example, autonomous vehicles may be equipped with cameras for capturing street level images of roadways or objects along roadways.

Computer 110 may also control status indicators 138, in order to convey the status of the vehicle and its components to a passenger of vehicle 101. For example, vehicle 101 may be equipped with a display 225, as shown in FIG. 2, for displaying information relating to the overall status of the vehicle, particular sensors, or computer 110 in particular. The display 225 may include computer generated images of the vehicle's surroundings including, for example, the status of the computer, the vehicle itself, roadways, intersections, as well as other objects and information.

Computer 110 may use visual or audible cues to indicate whether computer 110 is obtaining valid data from the various sensors, whether the computer is partially or completely controlling the direction or speed of the car or both, whether there are any errors, etc. Vehicle 101 may also include a status indicating apparatus, such as status bar 230, to indicate the current status of vehicle 101. In the example of FIG. 2, status bar 230 displays “D” and “2 mph” indicating that the vehicle is presently in drive mode and is moving at 2 miles per hour. In that regard, the vehicle may display text on an electronic display, illuminate portions of vehicle 101, or provide various other types of indications. In addition, the computer may also have external indicators which indicate whether, at the moment, a human or an automated system is in control of the vehicle, that are readable by humans, other computers, or both.

In one example, computer 110 may be an autonomous driving computing system capable of communicating with various components of the vehicle. For example, computer 110 may be in communication with the vehicle's conventional central processor 160, and may send and receive information from the various systems of vehicle 101, for example the braking 180, acceleration 182, signaling 184, and navigation 186 systems in order to control the movement, speed, etc. of vehicle 101. In addition, when engaged, computer 110 may control some or all of these functions of vehicle 101 and thus be fully or merely partially autonomous. It will be understood that although various systems and computer 110 are shown within vehicle 101, these elements may be external to vehicle 101 or physically separated by large distances.

Systems and methods according to aspects of the disclosure are not limited to detecting any particular type of objects or observing any specific type of vehicle operations or environmental conditions, nor limited to any particular machine learning process, but may be used for deriving and learning any driving pattern with any unique signature to be differentiated from other driving patterns.

The sample values, types and configurations of data described and shown in the figures are for the purposes of illustration only. In that regard, systems and methods in accordance with aspects of the disclosure may include various types of sensors, communication devices, user interfaces, vehicle control systems, data values, data types and configurations. The systems and methods may be provided and received at different times (e.g., via different servers or databases) and by different entities (e.g., some values may be pre-suggested or provided from different sources).

As these and other variations and combinations of the features discussed above can be utilized without departing from the systems and methods as defined by the claims, the foregoing description of exemplary embodiments should be taken by way of illustration rather than by way of limitation of the disclosure as defined by the claims. It will also be understood that the provision of examples (as well as clauses phrased as “such as,” “e.g.”, “including” and the like) should not be interpreted as limiting the disclosure to the specific examples; rather, the examples are intended to illustrate only some of many possible aspects.

Unless expressly stated to the contrary, every feature in a given embodiment, alternative or example may be used in any other embodiment, alternative or example herein. For instance, any appropriate sensor for detecting vehicle movements may be employed in any configuration herein. Any data structure for representing a specific driver pattern or a signature vehicle movement may be employed. Any suitable machine learning processes may be used with any of the configurations herein.

What is claimed is:

1. A method to track visual targets captured by a video camera, comprising:
detecting data association between detections and targets, where detections are generated using one or more image based detectors (tracking-by-detections);
identifying one or more targets of interests and estimating a motion of each individual target; and
applying an Aggregated Local Flow Descriptor to accurately measure an affinity between a pair of detections and a Near Online Multi-target Tracking to perform multiple target tracking given a video sequence.

2. The method of claim 1, wherein the image based detectors comprise a Regionlet or a Deformable Part.

3. The method of claim 1, comprising:
obtaining one or more object hypotheses that contain false-positives or missed target objects; and
in parallel, determining optical flows using a Lucas-Kanade optical flow method to estimate local (pixel level) motion field in the images.

4. The method of claim 1, comprising using two inputs and images, generating a number of hypothetical trajectories for existing targets;

5. The method of claim 1, determining a consistent set of target trajectories using an inference method.

6. The method of claim 1, comprising applying a Conditional Random Field.

7. The method of claim 1, comprising identifying a new target by treating any tracklet as a potential new target and using a non-maximum suppression on tracklets to avoid having duplicate new targets.

8. The method of claim 1, comprising determining a likelihood of each target hypothesis using Aggregated Local Flow Descriptor (ALFD).

9. The method of claim 1, wherein the descriptor encodes image-based spatial relationship between two detections in different time frames using optical flow trajectories.

10. The method of claim 1, if the method identifies ambiguous target hypothesis, deferring a decision to a later time to avoid making errors.

11. The method of claim 1, comprising resolving the deferred decision after gathering more information.

12. The method of claim 1, comprising combining an output with other measures including one or more of: appearance similarity and target dynamics.

13. The method of claim 1, comprising generating candidate hypothetical trajectories using ALFD driven tracklets and determining the association using a parallelized junction tree.

14. The method of claim 13, wherein one or more association errors lead to a wrong result in terms of target motion estimation and high level reasoning on object behavior.

15. The method of claim 1, comprising learning model parameters w_{Δt} from a training dataset with a weighted voting, further comprising:
given a set of detections D₁^{T} and corresponding ground truth (GT) target annotations, assigning the GT target id to each detections;
for each detection dᵢ, measuring an overlap with all the GT targets in tᵢ and if a best overlap oᵢ is larger than a predetermined value, assigning a corresponding target id (idᵢ).

16. The method of claim 1, wherein the near-online multi-target tracking updates and outputs targets A^{t} in each time frame considering inputs in a temporal window [t−τ, t], further comprising:
applying a hypothesis generation and selection of clean targets A^{*t-1]}={A₁^{*t-1}−1, A₂^{*t-1}−1, . . . } that exclude associated detections in [t−1]−τ, t−1];
generating multiple target hypotheses Hₘ^{t}={ø, H_{m,2}^{t}, H_{m,3}^{t} . . . } for each target Aₘ^{*t-1} as well as newly entering targets, where ø (empty hypothesis) represents a termination of the target and each H_{m,k}^{t} indicates a set of candidate detections in [t−τ, t] associated to a target and each H_{m,k}^{t} contains 0 to τ detections;
given a set of hypotheses for existing and new targets, locating the most consistent set of hypotheses (MAP) for the targets (one for each) using a graphical model; and
fixing any association error for detections within the temporal window [t−τ, t]) made in the previous time frames.

17. A system to track targets in a video, comprising:
a camera to capture video; and
a processor coupled to the camera and running:
code for estimating data association between detections and targets, where detections are generated using one or more image based detectors (tracking-by-detections); and
code for identifying one or more target of interests and estimating a motion of each individual; and
code for applying an Aggregated Local Flow Descriptor to accurately measure an affinity between a pair of detections and a Near Online Multi-target Tracking to perform multiple target tracking given a video sequence.

18. A car, comprising:
a user interface to control the car;
a video camera to capture scenes; and
a processor coupled to the video camera and to the user interface and running:
code for estimating data association between detections and targets, where detections are generated using one or more image based detectors (tracking-by-detections); and
code for identifying one or more target of interests and estimating a motion of each individual; and
code for applying an Aggregated Local Flow Descriptor to accurately measure an affinity between a pair of detections and a Near Online Multi-target Tracking to perform multiple target tracking given a video sequence.

19. The system of claim 18, wherein the image based detectors comprises a Regionlet or Deformable Part.

20. The system of claim 18, comprising:
code for obtaining one or more object hypotheses that contain false-positives or missed target objects; and
an optical flow analyzer operating in parallel to estimate local (pixel level) motion field in the images.
